(19) United States
(12) Patent Application Publication
(10) Pub. No.: US 2026/0154847 A1
(43) Pub. Date: Jun. 4, 2026

(54) METHOD AND DEVICE FOR CALIBRATING A CAMERA USED FOR OPTICAL RECOGNITION

(71) Applicant: IDEMIA PUBLIC SECURITY FRANCE, Courbevoie (FR)

(72) Inventors: Marina POUET, Courbevoie (FR); Cédric THUILLIER, Courbevoie (FR); Sébastien BRONSART, Courbevoie (FR); Jean BEAUDET, Courbevoie (FR); Stéphane PEPING, Courbevoie (FR)

(73) Assignee: IDEMIA PUBLIC SECURITY FRANCE, Courbevoie (FR)

(21) Appl. No.: 19/351,443

(22) Filed: Oct. 7, 2025

(30) Foreign Application Priority Data
Oct. 31, 2024 (FR) FR2411932

(51) Int. Cl. G06T 7/80; G06T 7/60; G06V 10/766; G06V 20/00; G06V 20/50; G06V 40/40; G06V 40/60

(52) U.S. Cl. CPC G06T 7/80; G06T 7/60; G06V 10/766; G06V 20/50; G06V 20/95; G06V 40/40; G06V 40/67; G06T 2207/30176; G06T 2207/30201

(57) ABSTRACT

The present invention relates to a method for calibrating mobile terminals of the same model equipped with a camera used in a contactless optical recognition method comprising the following steps of:
obtaining images of subjects captured by terminals of the same terminal model, with each image being associated with a focus value used when capturing;
determining, for each image, a resolution of the subject in the image based on the known size of the subject and the pixel size of the subject in the image;
estimating a relationship between the focus value and the resolution of the subject in the image by regression over a set of points, with each point corresponding to the focus value and resolution pair of the subject in the image for an obtained image;
transmitting said relationship to the terminals of the same model.

The invention relates to camera optical recognition systems. Optical recognition can involve the optical recognition of a user, via fingerprint recognition, palm print recognition or even facial recognition. It can also involve the optical recognition of a document, such as an official identity document.

In the field of acquiring images of fingerprints, palm prints, faces or documents for optical recognition purposes, images need to be obtained in which the resolution of the print is known and is sufficiently accurate. The resolution is defined by the number of points in the captured image per unit length of the captured object. This is also referred to as the resolution of the subject in the image. For example, the resolution can be expressed in dots per inch (DPI) or dots per centimeter (DPC). This resolution should not be confused with the resolution of a printed image, which is expressed as the number of dots per unit length of the printed image. When the sensor used to capture the image operates in contact with the object, the acquisition system knows the resolution. The sensors used in contact fingerprint capture systems obtain images with a resolution that generally ranges between 500 DPI and 1,000 DPI.

Due to the proliferation of mobile terminals such as smartphones or tablets, which are generally equipped with high-quality cameras, optical recognition systems are tending to replace the dedicated contact sensors with these terminals. The camera systems fitted to these terminals require the captured object being at least a few centimeters away from the lens of the camera in order to focus and therefore obtain a clear image. The precise distance between the subject and the camera lens is not controlled. However, the resolution of the obtained image depends on this distance and decreases as the subject moves farther away. These optical recognition systems are generally deployed on a very large scale, with each user using their own terminal to authenticate themselves, typically with a service.

These optical recognition systems can be used to secure access to online services, as well as buildings. They also can be used to secure transactions. The specific use of the optical recognition system and the interactions between said system and the service it provides secure access to are not the subject of this document.

The optical recognition algorithms used to authenticate the subject require a minimum resolution to ensure that they operate properly. In the case of fingerprints, it has been found, for example, that a minimum resolution of 500 DPI is desirable. The actual resolution thresholds to be met depend on the category of the subject, namely a fingerprint, a palm print, a face or a document, but also on the optical recognition algorithms that are used.

These optical recognition systems are prone to attempted fraud aimed at authenticating a representation of the subject as the original subject. This representation can be, for example, a photograph of the subject presented to the camera. This representation is rarely to the scale of the subject. Typically, the representation is larger than the original in an attempt to better represent the details in the hope of deceiving the optical recognition system.

Detecting this type of fraud improves the reliability of the optical recognition.

The described invention aims to overcome this problem.

### DISCLOSURE OF THE INVENTION

To this end, the invention proposes a method for calibrating per terminal model that allows a relationship to be established between the focus values, i.e., the focus distance of the camera, and the resolution of the subject in the image. The focus value is typically part of the metadata associated with the captured image. The size of the subject, such as a print or a document, although it can vary slightly from one subject to another, is sufficiently set for the same type of subject to allow this relationship to be statistically established over a set of captured images of the subject. In the case of facial recognition, the distance between the eyes is used as the size of the subject. This distance is sufficiently set for the purposes of the application, with the average distance between the eyes being 65 mm for an adult. Once this relationship has been established, it is then possible, when a new image of a subject is captured with a view to their optical recognition, to compare the expected resolution obtained by this relationship with the resolution measured in the image of the subject. A significant difference between this expected resolution and the measured resolution indicates a strong presumption of attempted fraud.

Therefore, a method is proposed for calibrating mobile terminals of the same model equipped with a camera used in a contactless optical recognition method, characterized in that it comprises the following steps of:
obtaining a first plurality of images of subjects captured by terminals of the same terminal model, with each image being associated with a focus value used when capturing;
determining, for each image, a resolution of the subject in the image based on the known size of the subject and the pixel size of the subject in the image;
estimating a first relationship between the focus value and the resolution of the subject in the image by regression over a set of points, with each point corresponding to the focus value and resolution pair of the subject in the image for an obtained image;
transmitting the estimated first relationship to the terminals of the same model.

In some embodiments, the step of estimating a relationship is executed when the number of obtained images is greater than a predetermined threshold.

In some embodiments, the transmission step is executed when a correlation coefficient obtained during the regression is greater than a predetermined threshold.

In some embodiments, the step of estimating a relationship is followed by a step of computing the distance of each point from the obtained curve and a step of estimating a new relationship performed by excluding the points farthest from the curve obtained during the first estimation.

In some embodiments, after the first relationship is estimated, the method comprises the following steps of:
obtaining a second plurality of images of subjects captured by terminals of the same terminal model, with each image being associated with a focus value used when capturing;
determining, for each image in the second plurality of images, a resolution of the subject in the image based on the known size of the subject and the pixel size of the subject in the image;
estimating a second relationship between the focus value and the resolution of the subject in the image by regression over a set of points, with each point corresponding to the focus value and resolution pair of the subject in the image for an obtained image belonging to the first or the second plurality of images;
transmitting the estimated second relationship to the terminals of the same model if the difference between the first relationship and the second relationship is greater than a predetermined threshold.

In some embodiments, the step of obtaining a first plurality of images comprises, for each image, a step of detecting a type of subject represented in the image.

In some embodiments, the subject belongs to one of the following types of subjects:
a finger;
a palm of a hand;
a face;
a document.

A method for optically recognizing a subject is also proposed comprising, via a terminal comprising a camera, the following steps of:
capturing an image of the subject associated with the focus value used when capturing;
optically recognizing the subject; characterized in that it comprises the following steps of:
obtaining a relationship between the focus value and the resolution of the subject in the image;
determining a measured resolution of the subject in the image based on a known size of the subject and the pixel size of the subject in the image;
determining an expected resolution of the subject in the image determined based on the focus value and the obtained relationship;
rejecting the captured image on suspicion of fraud when the measured resolution and the expected resolution differ by a value that is greater than a predetermined threshold.

In some embodiments, the method comprises the following steps of:
determining a resolution range of the subject in the image relative to the optical recognition of the subject;
determining the corresponding range of focus values based on the relationship;
determining an indication to move the subject closer or farther away when capturing when the focus value is outside the range; and
displaying the indication when capturing the image.

A computer program product comprising instructions for implementing the method according to the invention when said program is executed by a processor is also proposed.

A computer-readable non-transitory storage medium storing a program for implementing the method according to the invention when this program is executed by a processor is also proposed.

A device for calibrating terminals of the same model equipped with a camera used in an optical recognition method is also proposed, characterized in that it comprises a processor configured to execute the following steps of:
obtaining a first plurality of images of subjects captured by terminals of the same terminal model, with each image being associated with a focus value used when capturing;
determining, for each image, a resolution of the subject in the image based on the known size of the subject and the pixel size of the subject in the image;
estimating a first relationship between the focus value and the resolution of the subject in the image by regression over a set of points, with each point corresponding to the focus value and resolution pair of the subject in the image for an obtained image;
transmitting the estimated first relationship to the terminals of the same model.

A mobile terminal for contactless optical recognition of a subject is also proposed, the terminal comprising a camera and a processor configured to execute the following steps of:
capturing an image of the subject associated with the focus value used when capturing;
optically recognizing the subject; characterized in that it comprises the following steps of:
obtaining a relationship between the focus value and the resolution of the subject in the image;
determining a measured resolution of the subject in the image based on a known size of the subject and the pixel size of the subject in the image;
determining an expected resolution of the subject in the image determined based on the focus value and the obtained relationship;
rejecting the captured image when the measured resolution and the expected resolution differ by a value that is greater than a predetermined threshold.

A further aim of the present invention is a computer program comprising instructions for implementing the method described above when said program is executed by a processor.

This program can use any programming language (for example, an object language or another language) and can be in the form of interpretable source code, of partially compiled code, or of fully compiled code.

Another aspect relates to a non-transitory storage medium for a computer-executable program, comprising a set of data representing one or more programs, with said one or more programs comprising instructions for, when said one or more programs are executed by a computer comprising a processing unit operationally connected to memory means and to an input/output interface module, executing all or part of the method described above.

### BRIEF DESCRIPTION OF THE DRAWINGS

Further features, details and advantages of the invention will become apparent upon reading the following detailed description. This description is purely illustrative and should be read with reference to the accompanying drawings, in which:

FIG. 1 illustrates the system for capturing a subject by means of an optical recognition application running on a mobile terminal;

FIG. 2 illustrates the architecture of an optical recognition system in embodiments of the invention;

FIG. 3 illustrates the main steps of a calibration method according to one embodiment of the invention;

FIG. 4 illustrates the main steps of the calibration method and its use by the terminal in embodiments of the invention;

FIG. 5 is a schematic block diagram of an information processing device for implementing one or more embodiments of the invention.

### DETAILED DESCRIPTION

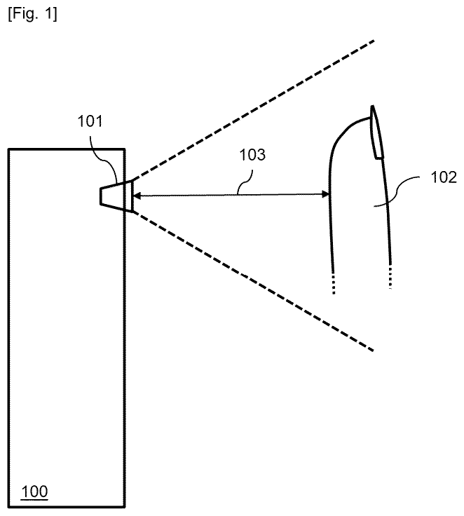

FIG. 1 illustrates the system for capturing a subject 102 via an optical recognition application running on a mobile terminal 100.

The mobile terminal 100 is typically a smartphone, a digital tablet or any type of computer terminal equipped with a processor capable of executing a computer program and a camera 101 capable of taking an image of a subject 102. The terminal also must be equipped with means for communicating with a data communication network.

The terminals operating within the optical recognition system can be very diverse. However, each terminal corresponds to a terminal model. Therefore, a terminal model is associated with a well-defined terminal model and a well-defined camera type. Therefore, the behavior of the capture system is considered to be uniform for a given terminal model, despite possible slight variations due to the inevitable fluctuations in the manufacturing process. A terminal model is identified by a model identifier, which is generally introduced into the metadata associated with each image captured by the terminal. It is therefore possible to identify the terminal model, and therefore the camera, used to capture an image based on the metadata associated with this image when it exists. This model identifier is also stored by the operating system of the terminal and is accessible to the applications running on the terminal, and more specifically to the optical recognition application described hereafter. The terminal model therefore can be obtained either from the image metadata or by the application from the operating system (for example via the camera API).

The camera 101 is made up of a photosensitive sensor and a lens. It is an autofocus type camera. This means that, depending on the distance 103 between the lens and the subject 102, the camera is able to automatically focus on the subject 102. This focus is represented by a focus value, which directly depends on the distance 103 between the lens and the subject 102. The focus value therefore represents the distance 103 between the camera lens and the subject 102.

The subject 102 shown in the figure is a finger, the image of which is used for fingerprint recognition. The system is similar in the case of a palm for palm recognition, a face for facial recognition, or a document for the recognition of an official document, such as an identity document.

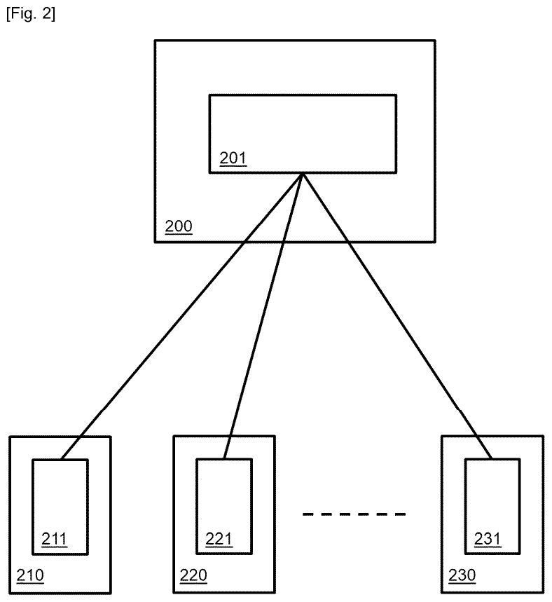

FIG. 2 illustrates the architecture of an optical recognition system in embodiments of the invention.

The optical recognition system is controlled by an optical recognition software service 201 hosted by a remote, centralized platform 200. The platform 200 is connected to a data communication network, typically the Internet. The platform 200 can be physically made up of one or more servers connected to each other to form a cluster of servers, depending on the resources required by the software service 201.

The optical recognition system is also made up of a set of mobile terminals 210-230. These mobile terminals are made up of different models. They respectively host the mobile applications 211-231 responsible for controlling optical recognition on the terminals. These mobile applications 211-231 are particularly responsible for managing capturing images of the subject for the purposes of optical recognition.

The mobile terminals 210-230 are also connected to the data communication network, typically via a mobile telephone network. Thus, the mobile applications 211-231 are able to communicate with the optical recognition service 201 in order to exchange data therewith.

The potential exchanges between the mobile applications 211-231 and the optical recognition service 201 related to the optical recognition itself are not described in this document. Only the exchanges related to the calibration method and its use to detect fraud are described herein, as described hereafter. In the described embodiment, the optical recognition service 201 is also responsible for calibrating the terminals 210-230. In other embodiments, the calibration may be handled by a calibration service separate from the optical recognition service 201. This calibration service can be hosted by the platform 200 or by another similar platform connected to the data communication network. When the optical recognition service and the calibration service are separate, the calibration steps described in this document as being performed by the optical recognition service are performed by the calibration service. The images required for calibration are then transmitted to the calibration service by the terminals, which means that the terminals transmit their images to both services. Alternatively, the optical recognition service processes the images, notably instantaneously, with the calibration information it has in a memory and transmits the images received from the terminals to the calibration service. In both cases, the calibration service is centralized and receives the images received from the various terminals, allowing it to collect as much data as possible from the various terminals.

Within the context of this method, each time a terminal captures an image for optical recognition purposes, the mobile application transmits at least the captured image of the subject, the terminal model identifier and the focus value used when capturing to the optical recognition service 201. The terminal model identifier and the focus value are typically included in the metadata associated with the image. When this is not the case, they can be transmitted together with the image.

The optical recognition service 201 receives these images associated with a terminal model identifier and a focus value. The optical recognition service is responsible for estimating calibration values based on the information received from the mobile applications. This estimation is undertaken per terminal model. For each terminal model, the optical recognition service accumulates information originating from the various terminals in this domain, and when it has received enough information it estimates the calibration information for the relevant terminal model. This calibration information is then transmitted by the optical recognition service to the terminals of the relevant model.

These exchanges are not necessarily synchronous. The terminals do not need to be connected to the optical recognition service when the image is captured. For example, the terminal may be out of range of the communication network when the image is captured. In this case, the terminal stores the information to be transmitted and transmits it to the optical recognition service the next time it reconnects to the network. Similarly, the optical recognition service may wait for the first reconnection of a terminal to the network before sending it the calibration information. In the preferred embodiment of the invention, the mobile application requests the calibration information from the optical recognition service, for example when it is launched. In response to this request, the optical recognition service transmits the calibration information if it is available. When the calibration information is not available, the response to the request transmits information indicating that the calibration information is unavailable.

The calibration information is stored by the recognition service. Thus, when a new terminal connects to the recognition service for the first time, and when the calibration information has been estimated for the terminal model, this calibration information can be transmitted thereto.

In one embodiment, in which the optical recognition service and the calibration service are separate, the calibration information is stored by the calibration service. The terminal may be out of range of the communication network when the image is captured, in which case the terminal stores the information to be transmitted and transmits it to the calibration service the next time it reconnects to the network.

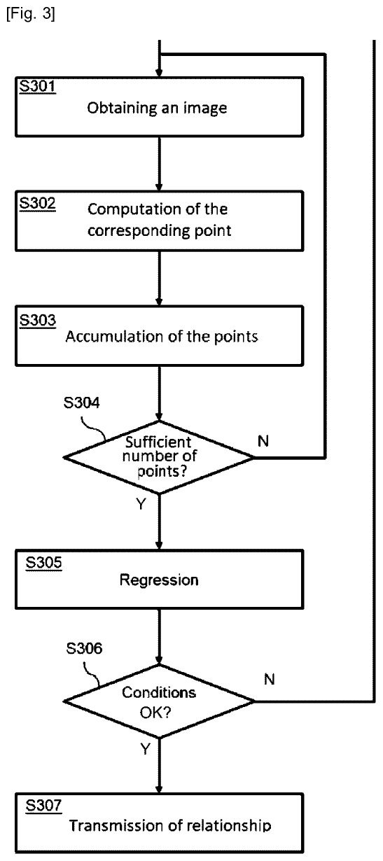

FIG. 3 illustrates the main steps of a calibration method according to one embodiment of the invention.

The calibration method is typically executed by the optical recognition application 201. Alternatively, this method can be implemented by a dedicated calibration service separate from the optical recognition service, as described above. It aims to estimate a relationship between the focus value and the resolution of the subject in the obtained image. It should be noted in this case that the resolution refers to the resolution in relation to the size of the subject. Once obtained, this relationship constitutes the calibration data.

During a first step S301, the optical recognition service receives, from the terminal, notably from the mobile application of a terminal, an image of the subject captured during optical recognition associated with the terminal model identifier and the associated focus value. This information is sent to the calibration service for processing when said service is separate from the optical recognition service.

During a step S302, the corresponding point is computed. The point is defined in the two-dimensional space with the focus values on the abscissa and the resolution relative to the subject on the ordinate. The physical size of the subject is known. For example, if the subject is a finger within the context of fingerprint recognition, the size can correspond to the average width of a human finger. This value is a predefined constant of the method, stored in a table, for example.

The size of the captured image in this case is assumed to be identical for all the terminals of a particular model. Indeed, the size of the captured image is controlled by the mobile application when capturing an image, which can impose a fixed size for all the terminals. In some embodiments, this size can vary, in which case these differences must be taken into account in the computation. It is then possible to normalize this size, i.e., to resize the received images to the same size in order to execute the computations.

The optical recognition service then detects the subject in the received image. This detection can be performed by any object detection algorithm known to a person skilled in the art, for example the YOLO (“You Only Look Once”) algorithm. Once the subject has been identified in the image, its type is determined and its size is extracted from the table. The type of subject is typically known, as recognition applications are typically dedicated to one type of subject. Alternatively, the type of subject can be determined by a classification algorithm in the event that the application can process several types of subjects. This determination of the type of subject also can be undertaken by the terminal, and the subject type information can be transmitted together with the image. The optical recognition service measures its size in the image, expressed in pixels. For example, in the case of a finger, the optical recognition service will measure the width of the finger in the image in pixels.

The ratio between the size of the subject measured in the image in pixels and the known size of the subject corresponds to the resolution of the subject in the received image.

The pair made up of the focus value and the resolution of the subject in the image constitutes the point associated with this image.

During a step S303, the computed point is stored in association with the relevant terminal model. The optical recognition service therefore accumulates the points computed for each image received by the relevant terminal model in a memory.

During a step S304, a test is undertaken to determine whether the number of points accumulated for the relevant terminal model is sufficient. This number of accumulated points is compared to a predetermined threshold. This predetermined threshold can depend on the type of subject and the terminal model. For example, in the case of documents, the size of the subject is precisely known, whereas the size of a finger is less precise, and more points then may need to be accumulated for a finger than for a document. The number of points must be sufficient to allow the relationship between the focus value and the resolution of the subject in the image to be estimated. In the embodiment, the subject is a finger, and the threshold values that are used are, for example, values between 100 and 1,000.

While the sufficient number of points has not been reached, the optical recognition service continues the accumulation by returning to step S301.

When a sufficient number of points have been accumulated, the method transitions to a regression step S305. This step aims to estimate the relationship between the focus value and the resolution of the subject in the image. This involves estimating the equation of the average curve representing the cloud of accumulated points. This equation is polynomial, for example, with this step then involving a polynomial regression step that is well known to a person skilled in the art. Alternatively, a non-parametric regression using kernel estimation, also known as the Parzen-Rosenblatt method, can be used.

In one embodiment of the invention, the equation is assumed to be linear, which is a special case of a polynomial equation. The regression is therefore linear and allows the equation of the line representing the accumulated points in the two-dimensional space of the focus values and resolutions of the subject in the image to be estimated.

During this initial calibration phase, fraud detection as described hereafter is not activated. Some of the images obtained in step S301 therefore can be the result of an attempted fraud. These images will typically generate points that can be described as abnormal, which will deviate from the curve representing the points originating from non-fraudulent images. By selecting a high enough threshold for the number of points, the number of abnormal points remains low enough to not significantly alter the estimation of the relationship.

In some embodiments of the invention, a new regression is performed without the points whose distance from the curve obtained during the first regression is greater than a threshold. This prevents these abnormal points from disrupting the estimation.

Once the relationship has been estimated, this relationship, which corresponds to the calibration result, is transmitted to all the terminals of the relevant model during a step S307. This transmission can assume different forms depending on the embodiments. The calibration information can be integrated into an update of the mobile application, in which case the transmission occurs when the mobile application is updated. Alternatively, the mobile application transmits a request for calibration information, for example when accessing the service. According to another variant, the terminals do not store the calibration information and download it each time an image is captured.

In some embodiments, an additional step S306 is introduced before transmission. During this step S306, additional conditions are tested before validating the calibration. For example, a correlation coefficient may be determined during the regression. This correlation coefficient represents the standard deviation of the points from the estimated curve. While this correlation coefficient is below a predetermined threshold, for example 0.95, the accumulation continues and the method returns to step S301. The calibration is validated and the relationship is transmitted in step S307 only when the correlation coefficient exceeds this threshold.

Once the relationship has been transmitted to the terminals, or made available thereto, the calibration is complete.

The method described herein basically contemplates four different types of subjects: the finger for fingerprint recognition, the palm of a hand for palm recognition, the face of the subject, and official documents. The calibration method is executed for a single type of subject. In the case of a single application that can recognize more than one type of subject, the data is accumulated and processed per subject type according to a first embodiment. In other embodiments, the calibration incorporates images of various types of subjects. In this case, as long as the known size of the subject used in the calibration method is indeed the same as the known size for the type of subject depicted in each image, the method operates in the same way.

One of the important parameters of the method is the assumed known size of the subject. In the case of official documents, as these are standardized, the size is actually precisely known. In the case of a finger or palm of the hand, the size that is used is a standard average size. However, this size varies slightly among the population. In the case of facial recognition, the size that is used is the distance between the eyes. This variability results in a loss of accuracy in the calibration method, yet without undermining its relevance. In some embodiments, the type of subject can be divided into sub-types in the case of a finger, a face or a palm. For example, a subtype per age group can be created and each age group can be associated with a different standard finger or palm size. In the case of facial recognition, an estimator also can be used to provide an estimate of the distance between the eyes based on the shape of the face. In the case of documents, a subtype also can be used, for example the size of an identity card can vary depending on the relevant country. The expected size of the subject used in the method then depends on the subtype of the subject.

In some embodiments, the data from all the subtypes is used for the calibration. In other embodiments, a calibration is performed per subject subtype.

In some embodiments, once this initial calibration is complete, a method involving continuous adaptation of the calibration is executed. This method is similar to the initial calibration method, with the following differences. Step S304 is omitted, as the number of accumulated points is now always sufficient. The condition in step S306 is modified. During step S306, a test is then undertaken to determine whether the obtained relationship differs from the current relationship by a value that is greater than a predetermined threshold, for example 5%.

When this is the case, the new estimate of the relationship, which is assumed to be more relevant because it is estimated over a larger number of points, is stored, notably in the server of the recognition service platform 200, and is transmitted to the terminals of the relevant model in order to be used as the correlation result. It becomes the new current relationship.

Thus, the calibration can be continuously refined.

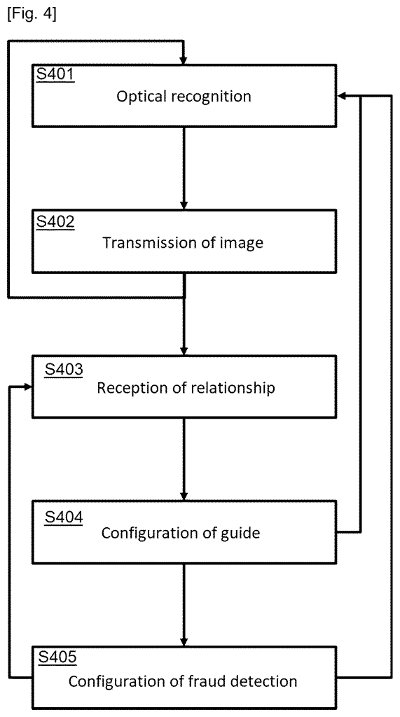

FIG. 4 illustrates the main steps of the calibration method and its use by the terminal in embodiments of the invention.

During a step S401, the terminal executes optical recognition under the control of the mobile application. This optical recognition step involves capturing an image of the subject. The captured image can be processed for optical recognition by the terminal, by the optical recognition service after transmission during a step S402, or even in a distributed manner, with some steps being executed by the terminal and others by the optical recognition service.

During a step S402, the terminal transmits the captured image associated with the terminal model identifier and the focus value that is used to the optical recognition service.

These steps S401 and S402 can be executed in a loop depending on how the user uses the optical recognition function of the terminal.

During a step S403, the terminal receives the calibration information, i.e., the estimate of the relationship between the focus values and the resolution of the subject in the image. This step can occur before steps S401 and S402 are executed, for example in the case of a terminal activating optical recognition when this terminal model has already been calibrated by the optical recognition service. For example, the terminal starting a first image capture phase connects to the recognition service, transmits its terminal model and requests the corresponding calibration information. If the calibration information is available for this terminal model, the service transmits it in response to the request. In this embodiment, step S403 can be seen as a sub-step of step S401.

In some embodiments, receiving the relationship triggers a step S404 of configuring a guide for the user of the optical recognition system. Indeed, a minimum resolution is generally required for the optical recognition to function properly. Optionally, a maximum resolution also can be set. Using the relationship received in step S403, it is possible to determine the focus values corresponding to these minimum and, optionally, maximum resolutions. It is thus possible to determine a range of focus values to be used during the optical recognition step S401 based on the relationship. During the subsequent optical recognition steps S401, an indication is generated inviting the user to move the subject closer to or farther away from the lens when capturing. This indication can be displayed on the terminal screen. This indication can be displayed until an image is obtained that is associated with a focus value within the desired range.

Step S403 of receiving the relationship also triggers a step S405 of configuring fraud detection. Indeed, the relationship can be used by the optical recognition step S401 to compare the resolution of the subject in the image as measured in the obtained image and the resolution of the subject in the expected image. The resolution of the subject in the expected image is the resolution of the subject in the image as provided by the received relationship based on the focus value associated with the captured image. When the difference between these measured and expected resolutions is greater than a predetermined threshold, for example 10%, fraud is suspected. Typically, this suspicion of fraud causes the optical recognition step S401 or any other appropriate processing to fail.

Alternatively, in embodiments where the optical recognition is executed by the optical recognition service, notably via a terminal browser, fraud detection is configured and performed on the platform by the optical recognition service.

Advantageously, the captured images for which fraud is suspected are not transmitted to the optical recognition service. Alternatively, they are transmitted together with an indication of suspected fraud. Advantageously, the focus and measured resolution information is also transmitted with the image and the indication of suspected fraud to enable any detections of fraud to be traced. Advantageously, when continuous adaptation of the calibration is performed, these fraudulent images are not then used for the calibration.

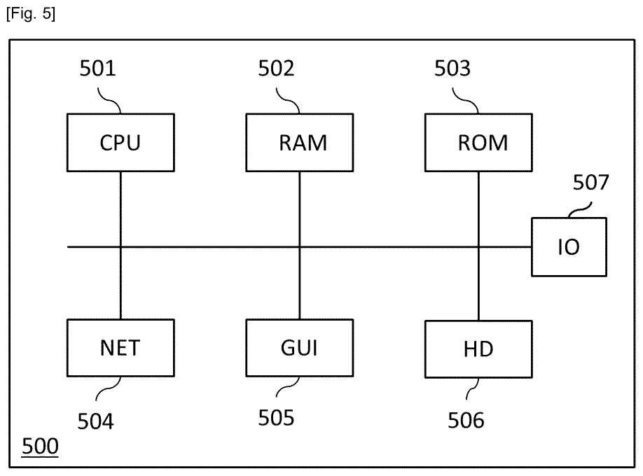

FIG. 5 is a schematic block diagram of an information processing device 500 for implementing one or more embodiments of the invention. The device 500 can correspond to a mobile terminal 210-230 or even to a server of the platform 200. The information processing device 500 can be a peripheral device such as a microcomputer, a workstation or a mobile telecommunications terminal. The device 500 comprises a communication bus connected to:
a central processing unit 501, such as a microprocessor, denoted CPU;
a random access memory 502, denoted RAM, for storing the executable code of the method for implementing the invention, as well as the registers adapted to store any variables and parameters required for implementing the method according to the embodiments of the invention; the memory capacity of the device can be supplemented by an optional RAM memory connected to an expansion port, for example:
a read-only memory 503, denoted ROM, for storing computer programs for implementing embodiments of the invention;
a network interface 504 is normally connected to a communication network, over which digital data to be processed is transmitted or received. The network interface 504 can be a single network interface, or can be made up of a set of different network interfaces (for example wired and wireless interfaces or different types of wired or wireless interfaces). Data packets are sent over the network interface for transmission or are read from the network interface for reception under the control of the software application running in the processor 501;
a user interface 505 for receiving input from a user or for displaying information for a user;
a storage device 506 as described in the invention and denoted HD;
an input/output module 507 for receiving/sending data from/to internal or external peripherals such as a hard drive, a camera, a removable storage medium or the like.

The executable code can be stored in a read-only memory 503, on the storage device 506 or on a removable digital medium such as a disk, for example. According to one variant, the executable code of the programs can be received by means of a communication network, via the network interface 504, in order to be stored in one of the storage means of the communication device 500, such as the storage device 506, before being executed.

The central processing unit 501 is adapted to control and direct the execution of instructions or portions of software code of the program or programs according to one of the embodiments of the invention, which instructions are stored in one of the aforementioned storage means. After being powered up, the CPU 501 is capable of executing instructions from the main RAM 502 relating to a software application. Such software, when executed by the processor 501, causes the described methods to be executed.

In this embodiment, the device is a programmable device that uses software to implement the invention. However, alternatively, the present invention can be implemented in hardware (for example in the form of a specific integrated circuit or ASIC).

Naturally, in order to meet specific requirements, a person skilled in the art of the invention could apply modifications to the above description.

Although the present invention has been described above with reference to specific embodiments, the present invention is not limited to the specific embodiments, and modifications within the scope of the present invention will be apparent to a person skilled in the art.

1. A method for calibrating mobile terminals of the same model equipped with a camera used in a contactless optical recognition method, wherein it comprises the following steps of:
obtaining a first plurality of images of subjects captured by terminals of the same terminal model, with each image being associated with a focus value used when capturing;
determining, for each image, a resolution of the subject in the image based on the known size of the subject and the pixel size of the subject in the image;
estimating a first relationship between the focus value and the resolution of the subject in the image by regression over a set of points, with each point corresponding to the focus value and resolution pair of the subject in the image for an obtained image;
transmitting the estimated first relationship to the terminals of the same model.

2. The method according to claim 1, wherein the step of estimating a relationship is executed when the number of obtained images is greater than a predetermined threshold.

3. The method according to claim 1, wherein the transmission step is executed when a correlation coefficient obtained during the regression is greater than a predetermined threshold.

4. The method according to claim 1, wherein the step of estimating a relationship is followed by a step of computing the distance of each point from the obtained curve and a step of estimating a new relationship performed by excluding the points farthest from the curve obtained during the first estimation.

5. The method according to claim 1, wherein it comprises, after the first relationship is estimated, the following steps:
obtaining a second plurality of images of subjects captured by terminals of the same terminal model, with each image being associated with a focus value used when capturing;
determining, for each image in the second plurality of images, a resolution of the subject in the image based on the known size of the subject and the pixel size of the subject in the image;
estimating a second relationship between the focus value and the resolution of the subject in the image by regression over a set of points, with each point corresponding to the focus value and resolution pair of the subject in the image for an obtained image belonging to the first or the second plurality of images;
transmitting the estimated second relationship to the terminals of the same model if the difference between the first relationship and the second relationship is greater than a predetermined threshold.

6. The method according to claim 1, wherein the step of obtaining a first plurality of images comprises, for each image, a step of detecting a type of subject represented in the image.

7. The method according to claim 1, wherein the subject belongs to one of the following types of subjects:
a finger;
a palm of a hand;
a face;
a document.

8. A method for optically recognizing a subject comprising, via a terminal comprising a camera, the following steps of:
capturing an image of the subject associated with the focus value used when capturing;
optically recognizing the subject;
wherein it comprises the following steps of:
obtaining a relationship between the focus value and the resolution of the subject in the image;
determining a measured resolution of the subject in the image based on a known size of the subject and the pixel size of the subject in the image;
determining an expected resolution of the subject in the image determined based on the focus value and the obtained relationship;
rejecting the captured image on suspicion of fraud when the measured resolution and the expected resolution differ by a value that is greater than a predetermined threshold.

9. The method according to claim 8, wherein it comprises the following steps of:
determining a resolution range of the subject in the image relative to the optical recognition of the subject;
determining the corresponding range of focus values based on the relationship;
determining an indication to move the subject closer or farther away when capturing when the focus value is outside the range; and
displaying the indication when capturing the image.

10. A computer program product comprising instructions for implementing the
method according to claim 1 when said program is executed by a processor.

11. A computer-readable non-transitory storage medium storing a program for implementing the method according to claim 1 when said program is executed by a processor.

12. The device for calibrating terminals of the same model equipped with a camera used in an optical recognition method, wherein it comprises a processor configured to execute the following steps of:
obtaining a first plurality of images of subjects captured by terminals of the same terminal model, with each image being associated with a focus value used when capturing;
determining, for each image, a resolution of the subject in the image based on the known size of the subject and the pixel size of the subject in the image;
estimating a first relationship between the focus value and the resolution of the subject in the image by regression over a set of points, with each point corresponding to the focus value and resolution pair of the subject in the image for an obtained image;
transmitting the estimated first relationship to the terminals of the same model.

13. A mobile terminal for contactless optical recognition of a subject, the terminal comprising a camera and a processor configured to execute the following steps of:
capturing an image of the subject associated with the focus value used when capturing;
optically recognizing the subject;
characterized in that it comprises the following steps of:
obtaining a relationship between the focus value and the resolution of the subject in the image;
determining a measured resolution of the subject in the image based on a known size of the subject and the pixel size of the subject in the image;
determining an expected resolution of the subject in the image determined based on the focus value and the obtained relationship;
rejecting the captured image when the measured resolution and the expected resolution differ by a value that is greater than a predetermined threshold.
